(19) United States
(12) Patent Application Publication
(10) Pub. No.: US 2025/0092200 A1
(43) Pub. Date: Mar. 20, 2025

(54) MODIFIED BISMALEIMIDE RESIN AND PREPARATION METHOD THEREOF

(71) Applicant: NAN YA PLASTICS CORPORATION, Taipei City (TW)

(72) Inventors: Te-Chao Liao, Taipei City (TW); Chi-Lin Chen, Taipei City (TW); Wen-Hua Lu, Taipei City (TW)

(73) Assignee: NAN YA PLASTICS CORPORATION, Taipei City (TW)

(21) Appl. No.: 18/503,184

(22) Filed: Nov. 7, 2023

(30) Foreign Application Priority Data
Sep. 19, 2023 (TW) 112135615

(51) Int. Cl. C08G 73/02

(52) U.S. Cl. CPC C08G 73/0246; C08G 73/0266

(57) ABSTRACT

A preparation method of a modified bismaleimide resin includes the following steps. Maleic anhydride is mixed with a bisamine compound to obtain a corresponding mixture. The mixture is heated. The bisamine compound has a main chain structure or fragment represented by Formula A, Formula B, or Formula C as described in the description.

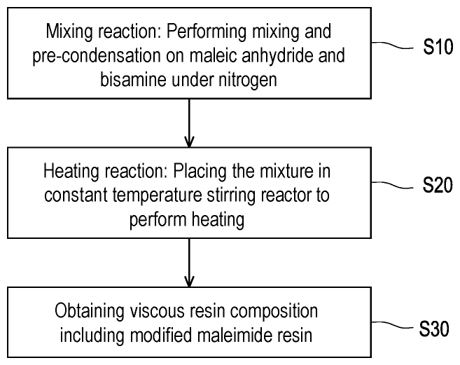

### CROSS-REFERENCE TO RELATED APPLICATION

This application claims the priority benefit of Taiwan application serial no. 112135615, filed on Sep. 19, 2023. The entirety of the above-mentioned patent application is hereby incorporated by reference herein and made a part of this specification.

### BACKGROUND

### Technical Field

The disclosure relates to a maleimide resin, and particularly, to a modified maleimide resin.

### Related Art

With the advancement of technology, electronic components are developing to be lighter, thinner, shorter, and smaller. Moreover, the advent of the fifth-generation mobile networks (abbreviated as 5G) and even the sixth-generation mobile networks (abbreviated as 6G) has led to a continuous increase in demands from the industry for high-frequency transmission, high-speed signal transmission, and low latency. Thus, professionals in the related arts are committed to developing substrate materials with a high temperature of glass transition (Tg), a low dielectric constant (Dk), a low dissipation factor (Df), and good heat resistance to satisfy requirements for dielectric properties (low dielectric constant and low dissipation factor) and heat resistance in electronic substrates.

General bismaleimide resins (mostly having aliphatic molecular structures) have good processability, but their moisture resistance may be poor, so such bismaleimide resins may not be used, or may not be suitably used, in high humidity environments or water environments, and may not be further adapted for high-end products or special specification products.

### SUMMARY

The disclosure provides a modified bismaleimide resin and a preparation method thereof.

A modified bismaleimide resin according to the disclosure has a structural formula being

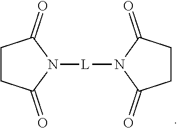

L is represented by Formula A, Formula B, or Formula C.

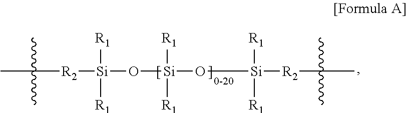

where R₁ is a C1-C3 alkyl group, and R₂ is a C1-C16 substituted or unsubstituted alkyl group, a substituted or unsubstituted cycloalkyl group, or a substituted or unsubstituted aryl group.

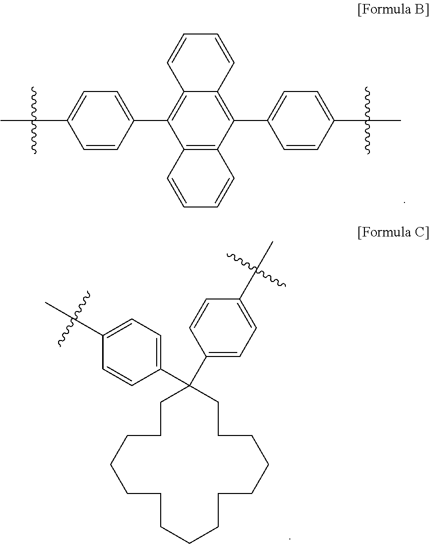 [SMILES: *c1ccc(-c2c3ccccc3c(-c3ccc(*)cc3)c3ccccc23)cc1 ; *c1ccc(C2(c3ccc(*)cc3)CCCCCCCCCCCCCCC2)cc1]

A preparation method of a modified bismaleimide resin according to the disclosure includes steps below. Maleic anhydride is mixed with a bisamine compound to form a corresponding mixture. The mixture is heated. The bisamine compound has a main chain structure or fragment represented by Formula A, Formula B, or Formula C described above.

Based on the above, the modified maleimide resin of the disclosure has at least a specific main chain structure or fragment, so it has a lower water absorption rate (i.e., good moisture resistance), lower coefficient of thermal expansion and dielectric properties, and thus has good applicability.

### BRIEF DESCRIPTION OF DRAWINGS

FIGURE is a schematic flowchart of a part of a preparation method of a polyphenylene ether type bismaleimide resin according to an embodiment of the disclosure.

### DESCRIPTION OF EMBODIMENTS

In the following detailed description, for illustration rather than limitation, exemplary embodiments disclosing specific details will be set forth to provide a thorough understanding of various principles of the disclosure. It will be apparent, however, to one of ordinary skill in the art that, benefiting from this disclosure, the disclosure may be practiced in other embodiments that depart from the specific details disclosed herein. Furthermore, descriptions of commonly known devices, methods, and materials may be omitted so as not to shift the focus from the description of the various principles of the disclosure.

Ranges may be expressed herein as “about” one particular value to “about” another particular value, which may also be expressed directly as one particular value and/or to another particular value. When expressing the range, another embodiment includes the one particular value and/or to the other particular value. Similarly, when values are expressed as approximations with the preceding word “about”, it will be understood that the particular value forms another embodiment. It will be further understood that an endpoint of each range is associated or unassociated with the other endpoint.

In the text herein, non-limiting terms (e.g., “may”, “can”, “for example”, or other similar terms) indicate non-essential or optional implementations, inclusions, additions, or presence.

In this document, a “substituted” functional group or compound may mean that a non-reactive hydrogen atom in the functional group or compound may be substituted by an isotope or substituted by a corresponding non-reactive group (e.g., an alkyl group).

Unless otherwise defined, all terms (including technical and scientific terms) used herein have the same meaning as commonly understood by one of ordinary skill in the art to which this disclosure belongs. It will also be understood that terms (such as those defined in commonly used dictionaries) should be interpreted to have meanings consistent with those in the relevant technical context and should not be interpreted in an idealized or overly formal sense, unless explicitly defined as such.

### Preparation of Modified Maleimide Resin

As shown in FIGURE, in this embodiment, a preparation method of a modified maleimide resin may include the following steps.

Step S10 includes a mixing reaction of performing mixing and pre-condensation on maleic anhydride and bisamine compound under nitrogen.

In an embodiment, the bisamine compound may be mixed with a solvent first to form a raw material mixture.

In an embodiment, the solvent is selected from a group consisting of toluene, methyl isobutyl ketone (MIBK), methyl ethyl ketone (MEK), dimethylacetamide (DMAC), dimethylformamide (DMF), and propylene glycol monomethyl ether (PM). However, the disclosure is not limited to the examples provided above. Considering the solubility of the corresponding bisamine compound, it is preferable to include a hydrophobic solvent or directly use a hydrophobic solvent.

In an embodiment, a ratio of the bisamine compound in the raw material mixture is about 30 wt % to 60 wt %.

In an embodiment, the bisamine compound may be a primary amine compound.

In an embodiment, the bisamine compound may have a nonpolar main chain structure represented by Formula A below. That is, the bisamine compound may be a bisamine compound having a fragment represented by Formula A below.

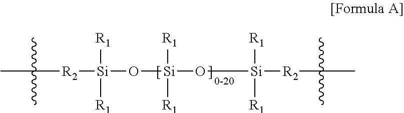

In Formula A, R₁ may be the same as or different from each other. RI may be an alkyl group having one to three carbons (which may be noted as C1-C3).

In Formula A, R₂ may be the same as or different from each other. R₂ may be a substituted or unsubstituted alkyl group having one to sixteen carbons (which may be noted as C1-C16), a substituted or unsubstituted cycloalkyl group, a substituted or unsubstituted aryl group (e.g., a phenyl group or a phenyl-containing group).

In an embodiment, the bisamine compound may include a nonpolar main chain structure represented by Formula A-1 below. In an embodiment, the bisamine compound having the fragment represented by Formula A-1 is one of the bisamine compounds having the fragment represented by Formula A.

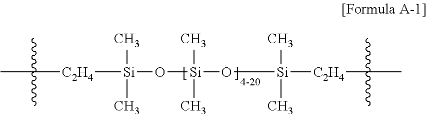

In an embodiment, the bisamine compound having the fragment represented by Formula A-1 may include a bisamine compound represented by Formula A-1-1 below.

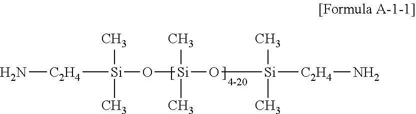

In an embodiment, the bisamine compound may include a nonpolar main chain structure represented by Formula A-2 below. In an embodiment, the bisamine compound having the fragment represented by Formula A-2 is one of the bisamine compounds having the fragment represented by Formula A.

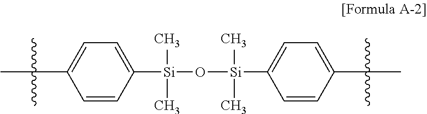 [SMILES: *c1ccc([Si](C)(C)O[Si](C)(C)c2ccc(*)cc2)cc1]

In an embodiment, the bisamine compound having the fragment represented by Formula A-2 may include a bisamine compound represented by Formula A-2-1 below.

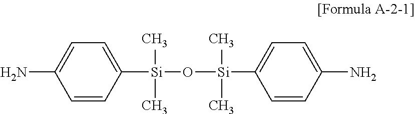 [SMILES: C[Si](C)(O[Si](C)(C)c1ccc(N)cc1)c1ccc(N)cc1]

In an embodiment, the bisamine compound may include a nonpolar main chain structure represented by Formula A-3 below. In an embodiment, the bisamine compound having the fragment represented by Formula A-3 is one of the bisamine compounds having the fragment represented by Formula A.

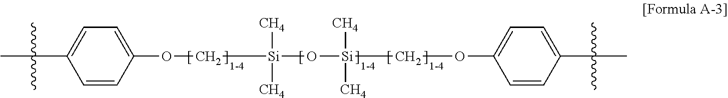

In an embodiment, the bisamine compound having the fragment represented by Formula A-3 may include a bisamine compound represented by Formula A-3-1 below.

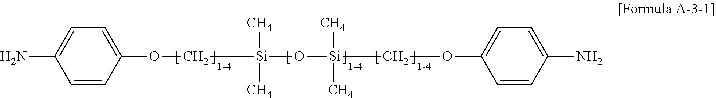

In an embodiment, the bisamine compound may have a nonpolar main chain structure represented by Formula B below. That is, the bisamine compound may be a bisamine compound having a fragment represented by Formula B below.

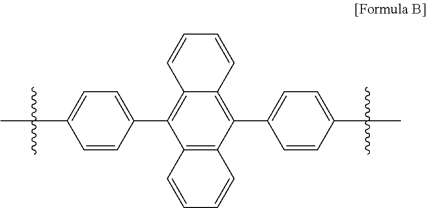 [SMILES: *c1ccc(-c2c3ccccc3c(-c3ccc(*)cc3)c3ccccc23)cc1]

In an embodiment, the bisamine compound having the fragment represented by Formula B may include a bisamine compound represented by Formula B-1 below.

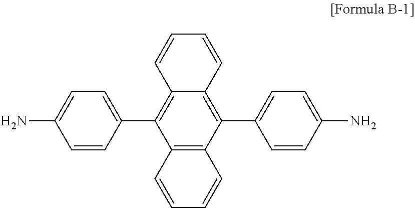 [SMILES: Nc1ccc(-c2c3ccccc3c(-c3ccc(N)cc3)c3ccccc23)cc1]

In an embodiment, the bisamine compound may have a nonpolar main chain structure represented by Formula C below. That is, the bisamine compound may be a bisamine compound having a fragment represented by Formula C below.

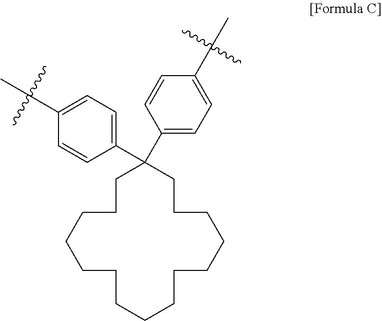 [SMILES: *c1ccc(C2(c3ccc(*)cc3)CCCCCCCCCCCCCCC2)cc1]

In an embodiment, the bisamine compound having the fragment represented by Formula C may include a bisamine compound represented by Formula C-1 below.

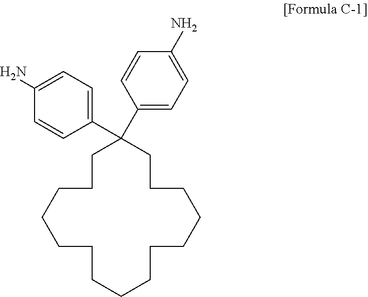 [SMILES: Nc1ccc(C2(c3ccc(N)cc3)CCCCCCCCCCCCCCC2)cc1]

Next, maleic anhydride is added to the raw material mixture.

In an embodiment, a molar number of the bisamine compound is about 2 to 3 times a general molar number of the maleic anhydride added. That is, a molar ratio of the maleic anhydride to the bisamine compound is about 1:2 to 1:3. The maleic anhydride may be a maleic anhydride solution with a concentration of 30 to 40 weight percent.

After mixing the bisamine compound with the maleic anhydride, the bisamine compound and the maleic anhydride may be subjected to a pre-condensation reaction at room temperature under a nitrogen atmosphere.

In an embodiment, a reaction rate of the pre-condensation reaction may be enhanced by addition of a catalyst. In an embodiment, a corresponding catalyst may be added to the raw material mixture before the bisamine compound is mixed with the maleic anhydride. In an embodiment, after the bisamine compound is mixed with the maleic anhydride, depending on the reaction conditions, the corresponding catalyst may be added all at once or in stages at appropriate timings or appropriate amounts.

In an embodiment, the catalyst may include triphenylphosphine (TPP, CAS: 603-35-0). In an embodiment, a ratio of the catalyst added in the raw material mixture is about 7 to 10 wt %.

In an embodiment, a reaction rate or reactivity (e.g., a corresponding ring-closing reaction) of the pre-condensation reaction may be enhanced by addition of a dehydrating agent. In an embodiment, after the bisamine compound is mixed with the maleic anhydride, depending on the reaction conditions, the corresponding dehydrating agent may be added all at once or in stages at appropriate timings or appropriate amounts.

In an embodiment, the dehydrating agent may include anhydrous 4-methylbenzenesulfonic acid (PTS/PTSA, CAS: 104-15-4).

Step S20 includes a heating reaction of placing the mixture (e.g., a mixture including the bisamine compound and the maleic anhydride, or further including an initial product after the pre-condensation reaction) in a constant temperature stirring reactor to perform a heating step.

In an embodiment, the heating step may include heating from room temperature to a set temperature (about 90° C. to 150° C.).

In an embodiment, the step may continue for about 10 hours to about 20 hours within the set temperature range to allow sufficient reaction and obtain a viscous resin composition including a modified maleimide resin (i.e., step S30).

A structural formula of the modified maleimide resin formed by the method described above may be represented by General Formula below.

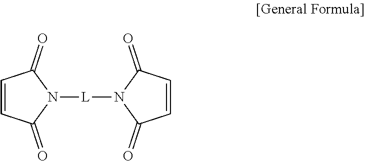

In General Formula, corresponding to the type of the bisamine compound used, L may be Formula A, Formula B, or Formula C described above.

Taking the bisamine compound used being a bisamine compound having a main chain structure represented by Formula A as an example, the formed modified maleimide resin may have the main chain structure represented by Formula A. For example, the structural formula of the modified maleimide resin may include a structure represented by Formula 1 below.

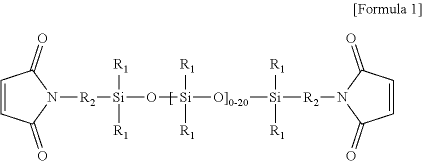

In Formula 1, the definitions for R₁ and R₂ are the same as previously described.

Specifically, taking the bisamine compound used being a bisamine compound having the main chain structure represented by Formula A-1 as an example, the formed modified maleimide resin may have the main chain structure represented by Formula A.

Taking the bisamine compound used being Formula A-1-1 as an example, the formed modified maleimide resin may include a structural formula represented by Formula 2 below.

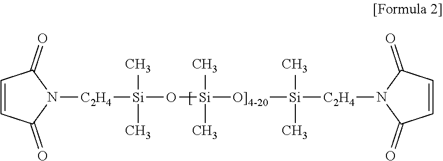

Taking the bisamine compound used being Formula A-2-1 as an example, the formed modified maleimide resin may include a structural formula represented by Formula 3 below.

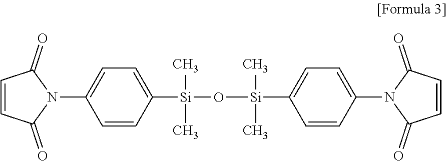 [SMILES: C[Si](C)(O[Si](C)(C)c1ccc(N2C(=O)C=CC2=O)cc1)c1ccc(N2C(=O)C=CC2=O)cc1]

Taking the bisamine compound used being Formula A-3-1 as an example, the formed modified maleimide resin may include a structural formula represented by Formula 4 below.

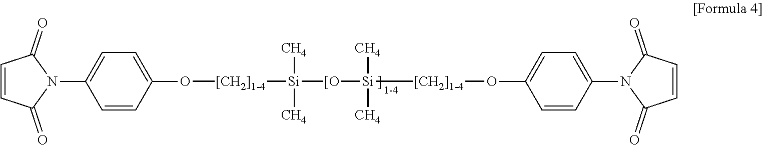

Taking the bisamine compound used being Formula B-1 as an example, the formed modified maleimide resin may include a structural formula represented by Formula 5 below.

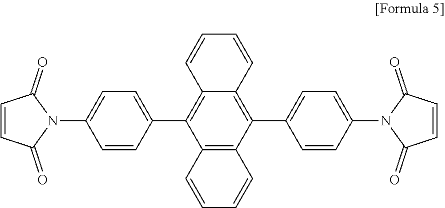 [SMILES: O=C1C=CC(=O)N1c1ccc(-c2c3ccccc3c(-c3ccc(N4C(=O)C=CC4=O)cc3)c3ccccc23)cc1]

Taking the bisamine compound used being Formula C-1 as an example, the formed modified maleimide resin may include a structural formula represented by Formula 6 below.

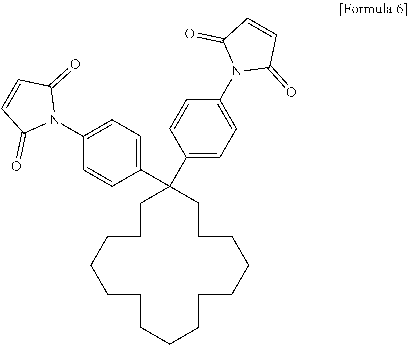 [SMILES: O=C1C=CC(=O)N1c1ccc(C2(c3ccc(N4C(=O)C=CC4=O)cc3)CCCCCCCCCCCCCCC2)cc1]

Based on the modified maleimide resin disclosed in the embodiment described above, compared to a conventional maleimide resin (i.e., an unmodified maleimide resin, different from the modified maleimide resin of the disclosure), a corresponding reaction is carried out with a specific bisamine compound and maleic anhydride in the disclosure, such that the nonpolar main chain structure of the bisamine compound replaces a main chain structure of a conventional maleimide resin. In this manner, the formed modified maleimide resin can still have the same or similar low dielectric constant and/or low dielectric loss properties. Moreover, with the chain type and/or nonpolar structure of the nonpolar main chain structure of the bisamine compound, the modified maleimide resin can have corresponding main-chain-type and/or nonpolar tendency properties, which can enhance a free volume and a nonpolar region of the overall structure of the modified maleimide resin (e.g., reducing the impact of polar functional groups). Thus, the modified maleimide resin can have a lower water absorption rate and/or a lower coefficient of thermal expansion (CTE).

In an embodiment, a number-average molecular weight (Mn) of the modified maleimide resin may range from about 400 g/mol to about 700 g/mol, and more preferably from about 450 g/mol to about 600 g/mol.

In an embodiment, a temperature of glass transition (Tg) of the modified maleimide resin may range from about 150° C. to about 300° C.

In an embodiment, a dielectric constant (Dk) of the modified maleimide resin may range from about 2.5 to about 3.5.

In an embodiment, a dissipation factor (Df) of the modified maleimide resin may range from about 0.0035 to about 0.0065.

In an embodiment, a water absorption rate of the modified maleimide resin may be less than or equal to about 3.4%, preferably less than or equal to about 3.1%, more preferably less than or equal to about 2.5%, still more preferably less than or equal to about 1.6%, and still more preferably less than or equal to about 0.5%.

In an embodiment, a free volume of the modified maleimide resin may range from about 1850 Å³ to about 3000 Å³.

In an embodiment, the modified maleimide resin may be applied to the manufacturing of electronic components (e.g., copper foil substrates). For example, the modified maleimide resin may be applied to a dielectric material in electronic components (e.g., a dielectric material in a copper foil substrate).

### EXAMPLES AND COMPARATIVE EXAMPLE

Examples and a comparative example will be provided below to specifically describe the disclosure, and the disclosure is not limited to the examples below.

A modified maleimide resin may be produced by the method described above. The main difference among the examples lies in that different bisamine compounds are used.

Example 1 was a modified maleimide resin formed of the bisamine compound represented by Formula C-1. The modified maleimide resin may include the structural formula represented by Formula 6.

Example 2 was a modified maleimide resin formed of the bisamine compound represented by Formula B-1. The modified maleimide resin may include the structural formula represented by Formula 5.

Example 3 was a modified maleimide resin formed of the bisamine compound represented by Formula A-3-1. The modified maleimide resin may include the structural formula represented by Formula 4.

Example 4 was a modified maleimide resin formed of the bisamine compound represented by Formula A-2-1. The modified maleimide resin may include the structural formula represented by Formula 3.

Example 5 was a modified maleimide resin formed of the bisamine compound represented by Formula A-1-1. The modified maleimide resin may include the structural formula represented by Formula 2.

The produced modified maleimide resin or a resin composition containing the produced modified maleimide resin may be applied to the manufacturing of copper foil substrates.

Comparative Example 1 directly used a commercially available bismaleimide resin composition (e.g., product name BMI, manufactured or sold by Japan KI Chemical Industry Co., Ltd., a weight average molecular weight of the entire resin composition being about 385), which includes an unmodified maleimide resin (e.g., 4,4′-Diphenylmethane bismaleimide, CAS: 13676-54-5).

A method of manufacturing a copper foil substrate will be described in detail as follows.

The modified maleimide resin of each of the examples described above and the maleimide resin of the comparative example were mixed in the same manner and formula composition ratio to form a resin varnish composition, and a copper foil substrate was prepared by a conventional method. The conventional method of preparing the copper foil substrate may include: impregnating a 2116 fiberglass cloth with the resin varnish composition described above, then drying for several minutes under conditions of about 170° C. (impregnation machine temperature), and adjusting and controlling the drying time to obtain a dried prepreg having a melt viscosity of about 4000 to 12000 poise. Then, four sheets of prepregs are stacked on each other between two sheets of copper foils about 35 μm thick to perform a lamination step.

The conditions/process of the lamination step are illustrated as follows.

Step 1: Raising the temperature from about 80° C. to about 195° C. at a rate of about 0.5 hours (which may be noted as 85/195° C., 0.5 hr).

Step 2: Increasing the pressure from about 7 kg/cm² to about 25 kg/cm² at a rate of about 0.5 hours (which may be noted as 7/25 kg/cm², 0.5 hr).

Step 3: Laminating for about 2.0 hours under conditions of a temperature of about 195° C. and a pressure of about 25 kg/cm² (which may be noted as 195° C./25 kg/cm², 2.0 hr).

The corresponding copper foil substrates produced may be subjected to corresponding tests (e.g., a dielectric constant (Dk) test or a dissipation factor (Df) test).

The properties of the modified maleimide resins of the examples and the unmodified maleimide resin of the comparative example are presented in Table 1 below. Moreover, for simplicity, electrical tests on the copper foil substrates manufactured with the modified or unmodified maleimide resin are also directly listed in Table 1.

TABLE 1

| | | | | | | Comparative |
|---|---|---|---|---|---|---|
| | Example 1 | Example 2 | Example 3 | Example 4 | Example 5 | Example |
| Molecular | 567 | 520 | 525 | 477 | 486 | 385 |
| weight | | | | | | |
| (Mn) | | | | | | |
| Tg (° C.) | 250 | 271 | 226 | 240 | 175 | 220 |
| Dk | 2.6 | 2.8 | 2.8 | 2.8 | 3.2 | 3.3 |
| Df | 0.0037 | 0.0041 | 0.0046 | 0.0047 | 0.0050 | 0.0041 |
| Absorption | 0.2 | 3.2 | 2.4 | 3.1 | 1.6 | 3.4 |
| rate 5 min | | | | | | |
| (%) | | | | | | |
| Free | 2897.15 | 1999.53 | 1885.33 | 1989.67 | 2591.46 | 1962.09 |
| volume (Å³) | | | | | | |

Each test method may adopt commonly used methods in the general related art of resins and is illustratively described as follows.

Number-average molecular weight (Mn): Analyzing the modified or unmodified maleimide resin using a gel permeation chromatograph (GPC), and calibrating with standard molecular weight polystyrene.

Temperature of glass transition (Tg) test: Analyzing the modified or unmodified maleimide resin using a differential scanning calorimeter (DSC), with a heating rate of about 20° C./min. For most maleimide resin materials, the temperature of glass transition and the coefficient of thermal expansion are slightly negatively correlated. Thus, when comparing two different types of maleimide resin materials, if the temperature of glass transition of one type is higher than the temperature of glass transition of the other type, it may be inferred that the coefficient of thermal expansion of the one type is lower than the coefficient of thermal expansion of the other type.

Dielectric constant (Dk) test: The test method included taking a square sample of about 5 cm×5 cm of the copper foil substrate with the copper foil removed, baking it in an oven at about 105° C. for about 2 hours, measuring its thickness with a thickness gauge, then clamping the sample into an impedance analyzer (Agilent E4991A), and taking an average value after obtaining dielectric constant Dk data at three points.

Dissipation factor test: The test method included taking a square sample of about 5 cm×5 cm of the copper foil substrate with the copper foil removed, baking it in an oven at about 105° C. for about 2 hours, measuring its thickness with a thickness gauge, then clamping the sample into an impedance analyzer (Agilent E4991A), and taking an average value after obtaining dissipation factor Df data at three points.

Water absorption rate test: Placing the modified or unmodified maleimide resin in a constant temperature and humidity box, leaving it for 5 minutes under conditions where the temperature reached about 85° C. and the humidity reached about 85%, and measuring a water absorption rate. [Difference in weight of sample before and after being in pressure cooker]÷[initial weight of sample]×100% is the water absorption rate.

Free volume (unit: A3): It may be simulated and estimated using general commercial software (e.g., Materials Studio/BIOVIA Materials Studio; other similar software may include but is not limited to Chemistry at HARvard Macromolecular Mechanics (CHARMm)). Reference may be made to official Help-Tutorials of the corresponding software for the simulation and estimation method, which will not be elaborated on herein. For most maleimide resin materials, the free volume and the water absorption rate are slightly negatively correlated. Thus, when comparing two different types of maleimide resin materials, if the free volume of one type is higher than the free volume of the other type, it may be inferred that the water absorption rate of the one type is lower than the water absorption rate of the other type. Thus, if a water absorption rate test has not yet been conducted on a maleimide resin material (e.g., only at an evaluation stage, substantial synthesis has not yet been conducted), the water absorption rate may be evaluated by the simulation method described above.

As shown in Table 1, compared to the commercially available maleimide resin commonly used in the manufacturing of electronic components (as shown in the comparative example), the modified maleimide resin of the disclosure is comparable in terms of electrical properties (e.g., the Very Low Loss level of the circuit board in terms of the dissipation factor (Df) is 0.0030 to 0.0065). Furthermore, as shown in Example 1, the corresponding dissipation factor may even be lower.

As shown in Table 1, compared to the commercially available maleimide resin commonly used in the manufacturing of electronic components (as shown in the comparative example), the modified maleimide resin of the disclosure may have a lower capacitive effect in terms of electrical properties (e.g., a smaller dielectric constant (Dk)).

As shown in Table 1, the coefficient of thermal expansion of the modified maleimide resin of the disclosure is comparable to the coefficient of thermal expansion of the commercially available maleimide resin commonly used in the manufacturing of electronic components (as shown in the comparative example). Furthermore, as shown in Example 1 to Example 4, the corresponding coefficient of thermal expansion may even be lower. Furthermore, as shown in Example 1 to Example 4, the coefficient of thermal expansion of the modified maleimide resin of the disclosure may even be lower. Thus, the modified maleimide resin of the disclosure may be more adaptable for the manufacturing or application of electronic components.

As shown in Table 1, the water absorption rate of the modified maleimide resin of the disclosure may be lower. Thus, the modified maleimide resin of the disclosure may be more adaptable for the manufacturing or application of electronic components.

In summary of the above, the modified maleimide resin of the disclosure has at least a specific main chain structure or fragment, so it has a lower water absorption rate (i.e., good moisture resistance), lower coefficient of thermal expansion and dielectric properties, and thus has good applicability.

Moreover, the bismaleimide resin formed by the manufacturing method of a bismaleimide resin described in the embodiment of the disclosure may be directly or indirectly applied to copper foil substrates and may be further processed into other consumer, industrial, or suitable electronic products.

What is claimed is:

1. A modified bismaleimide resin with a structural formula being: 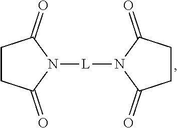
wherein L is represented by Formula A, Formula B, or Formula C below: 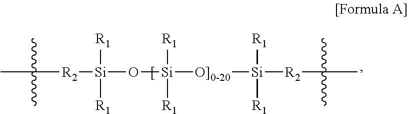
wherein R₁ is a C1-C3 alkyl group, and R₂ is a C1-C16 substituted or unsubstituted alkyl group, a substituted or unsubstituted cycloalkyl group, or a substituted or unsubstituted aryl group,

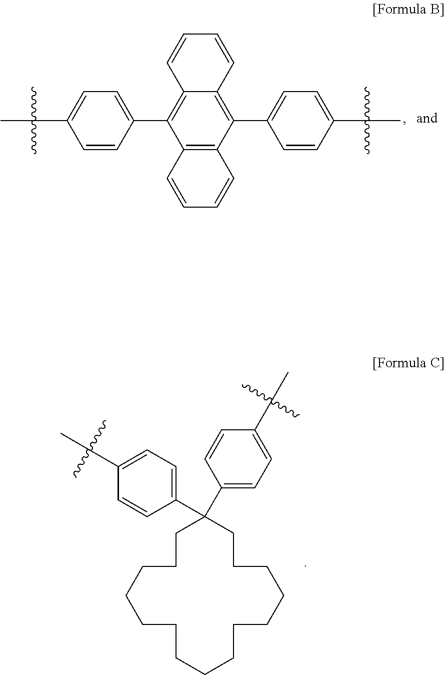 [SMILES: *c1ccc(-c2c3ccccc3c(-c3ccc(*)cc3)c3ccccc23)cc1 ; *c1ccc(C2(c3ccc(*)cc3)CCCCCCCCCCCCCCC2)cc1]

2. The modified bismaleimide resin according to claim 1, wherein Formula A is represented by Formula A-1 below:

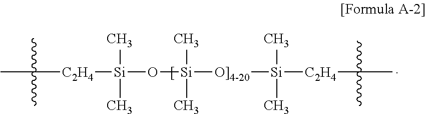

3. The modified bismaleimide resin according to claim 1, wherein Formula A is represented by Formula A-2 below:

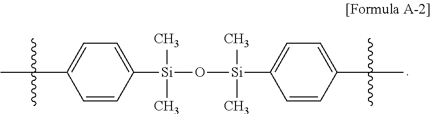 [SMILES: *c1ccc([Si](C)(C)O[Si](C)(C)c2ccc(*)cc2)cc1]

4. The modified bismaleimide resin according to claim 1, wherein Formula A is represented by Formula A-3 below:

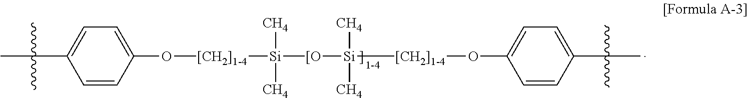

5. The modified bismaleimide resin according to claim 1, having a water absorption rate capable of being less than or equal to about 3.4%.

6. A preparation method of a modified bismaleimide resin, comprising:
mixing maleic anhydride with a bisamine compound to form a corresponding mixture; and
heating the mixture, wherein the bisamine compound has a main chain structure or fragment represented by Formula A, Formula B, or Formula C below: 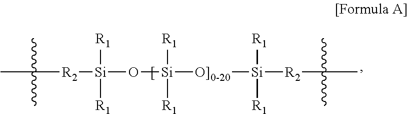
wherein R₁ is a C1-C3 alkyl group, and R₂ is a C1-C16 substituted or unsubstituted alkyl group, a substituted or unsubstituted cycloalkyl group, or a substituted or unsubstituted aryl group,

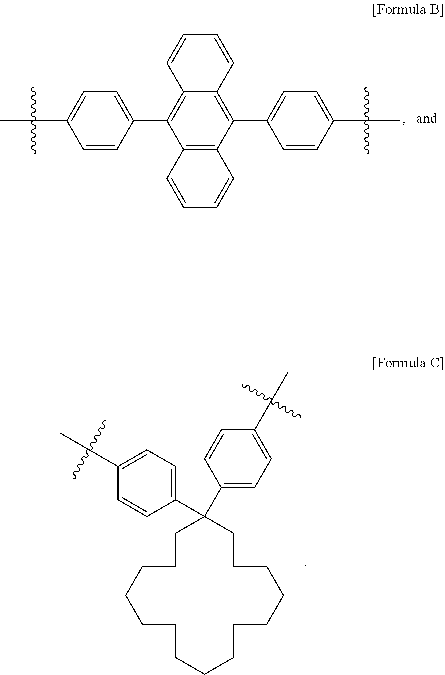 [SMILES: *c1ccc(-c2c3ccccc3c(-c3ccc(*)cc3)c3ccccc23)cc1 ; *c1ccc(C2(c3ccc(*)cc3)CCCCCCCCCCCCCCC2)cc1]

7. The preparation method of a modified bismaleimide resin according to claim 6, wherein the mixing of the maleic anhydride with the bisamine compound is carried out at room temperature.

8. The preparation method of a modified bismaleimide resin according to claim 6, wherein the mixing of the maleic anhydride with the bisamine compound is carried out under a nitrogen atmosphere.

9. The preparation method of a modified bismaleimide resin according to claim 6, wherein the heating of the mixture is heating to 90° C. to 150° C.

10. The preparation method of a modified bismaleimide resin according to claim 6. wherein the heating of the mixture is continued for 10 hours to 20 hours.
